(19) United States
(12) Patent Application Publication
(10) Pub. No.: US 2014/0287252 A1
(43) Pub. Date: Sep. 25, 2014

(54) POLYESTER POLYOL RESINS COMPOSITIONS

(71) Applicant: Momentive Specialty Chemicals Inc., Columbus, OH (US)

(72) Inventors: Denis Heymans, Ottignies-Louvain-la-Neuve (BE); Christophe Steinbrecher, Ottignies-Louvain-la-Neuve (BE); Cédric Le Fevere De Ten Hove, Ottignies-Louvain-la-Neuve (BE)

(73) Assignee: Momentive Specialty Chemicals Inc., Columbus, OH (US)

(21) Appl. No.: 14/352,243

(22) PCT Filed: Oct. 12, 2012
(86) PCT No.: PCT/EP2012/004319

§ 371 Date: Apr. 16, 2014

(30) Foreign Application Priority Data
Oct. 19, 2011 (EP) 11075231.8
Apr. 5, 2012 (EP) 12002496.3

(51) Int. Cl. C09D 167/00; C08G 63/78; C08G 63/91; C08G 63/66

(52) U.S. Cl. CPC C09D 167/00; C08G 63/66; C08G 63/78; C08G 63/914
USPC 428/458; 528/297; 525/448; 524/604; 428/480

(57) ABSTRACT

A composition of polyester polyol resins comprising a mixture of α,α-branched alkane carboxylic glycidyl esters derived from butene oligomers characterized in that the sum of the concentration of the blocked and of the highly branched isomers is maximum 55%, preferably below 40%, and most preferably below 30% weight on total composition.

The present invention relates to a composition of polyester polyol resins comprising a mixture of α,α-branched alkane carboxylic glycidyl esters derived from butene oligomers characterized in that the sum of the concentration of the blocked and of the highly branched isomers is maximum 55%, preferably below 40%, and most preferably below 30% weight on total composition.

More in particular the invention relates to polyester polyol resins compositions comprising of aliphatic tertiary saturated carboxylic acids or α,α-branched alkane carboxylic acids, which contain 9 or 13 carbon atoms and which provide glycidyl esters with a branching level of the alkyl groups depending on the olefin feedstock used and/or the oligomerization process thereof, and which is defined as below.

The purity of the glycidyl ester prepared from neo acids was found to have an influence on the glass temperature transition of the resin derived from, this was obtained by a flash distillation according to U.S. Pat. No. 6,136,991.

The modification of polyester resins by Cardura 10 or Cardura 5 were illustrated in WO 96/20968.

However, the industry is still interested in glycidyl ester derived from butane oligomers with chemical composition leading to high leveling of the coating and maintaining the over all good performance.

This invention is about the isomeric composition of the glycidyl ester modified polyester resin and the cured coating applied films.

It is generally known from e.g. U.S. Pat. No. 2,831,877, U.S. Pat. No. 2,876,241, U.S. Pat. No. 3,053,869, U.S. Pat. No. 2,967,873 and U.S. Pat. No. 3,061,621 that mixtures of α,α-branched alkane carboxylic acids can be produced, starting from mono-olefins, carbon monoxide and water, in the presence of a strong acid.

One of the more recent methods has been disclosed in EP 1033360. The problem of providing better softening derivatives of α,α-branched acids, manufactured from alkenes, carbon monoxide and water and a nickel catalyst was solved therein by a process, which actually comprised:
(a) oligomerization of butene;
(b) separation of butene dimers and/or trimers from the oligomerizate;
(c) conversion of the butene dimers and/or trimers into carboxylic acids;
(d) conversion of the carboxylic acids into the corresponding vinyl esters showing attractive softening properties when mixed into other polymers or if used as comonomers in coatings.

If the olefin feed is based on Raf. II or Raf III or any mixture rich in n-butene isomers on the total olefins, the subsequently mixture of neo-acid (C9 or C13 acids) derivatives will provide a mixture where the concentration of blocked and highly branched isomers is maximum 55%, preferably below 40%, and most preferably below 30%.

The glycidyl esters can be obtained according to PCT/EP2010/003334 or the U.S. Pat. No. 6,433,217.

We have discovered that well chosen blend of isomers of the glycidyl ester of mixture compositions of neo-acid (C9 or C13 acids) glycidyl ester, is providing for example a good leveling of a coating, and is a mixture where the sum of the concentration of blocked and highly branched isomers is maximum 55%, preferably below 40%, and most preferably below 30% weight on total composition.

We have further discovered that well chosen blend of isomers of the glycidyl ester of for example, neononanoic acids give different and unexpected performance in combination with some particular polymers such as polyester polyols.

The ratio between primary and secondary hydroxyl can be modulated as given in WO 01/25225.

The isomers are described in Table 1 and illustrated in Scheme 1.

We have found that the performance of the glycidyl ester compositions derived from the branched acid is depending on the branching level of the alkyl groups R¹, R² and R³, for example the neononanoic acid has 3, 4 or 5 methyl groups. Highly branched isomers are defined as isomers of neo-acids having at least 5 methyl groups.

Neo-acids, for example neononanoic acids (V9) with a secondary or a tertiary carbon atoms in the β position are defined as blocking isomers.

Mixture compositions of neononanoic (C9) acids glycidyl esters providing for example a good leveling of a coating, is a mixture where the sum of the concentration of the blocked and of the highly branched isomers derivatives is maximum 55%, preferably below 40%, and most preferably below 30% weight on total composition.

Furthermore the above compositions of neononanoic acids glycidyl esters mixture is comprising 2,2-dimethyl heptanoic acid glycidyl ester or 2-methyl 2-ethyl hexanoic acid glycidyl ester or 2-methyl 2-ethyl 3-methyl pentanoic acid glycidyl esters.

Furthermore the above compositions of neononanoic acids glycidyl esters mixture is comprising 2-methyl 2-ethyl 3-methyl pentanoic acid glycidyl esters (sum of stereoisomers) below 40%, preferably below 30% and most preferably below or equal 25% weight on total composition.

Furthermore the above compositions of neononanoic acids glycidyl esters mixture is comprising 2-methyl 2-ethyl hexanoic acid glycidyl ester above 10%, preferably above 30% and most preferably above 45% weight on total composition.

The above compositions of the glycidyl ester mixture is comprising 2,2-dimethyl heptanoic acid glycidyl ester and 2-methyl 2-ethyl hexanoic acid glycidyl ester and 2-methyl 2-ethyl 3-methyl pentanoic acid glycidyl esters (sum of stereoisomers) is above 40%, preferably 55% and most preferably 65% weight on total composition.

A preferred composition is comprising a mixture of 2,2-dimethyl heptanoic acid glycidyl ester in 1 to 15 weight % and 2-methyl 2-ethyl hexanoic acid glycidyl ester in 40 to 70 weight % and 2-methyl 2-ethyl 3-methyl pentanoic acid glycidyl esters (sum of stereoisomers) in 8 to 32 weight % on total composition.

A further preferred composition is comprising a mixture of 2,2-dimethyl heptanoic acid glycidyl ester in 2 to 10 weight % and 2-methyl 2-ethyl hexanoic acid glycidyl ester in 47 to 61 weight % and 2-methyl 2-ethyl 3-methyl pentanoic acid glycidyl esters (sum of stereoisomers) in 10 to 25 weight % on total composition.

The above glycidyl esters compositions can be used for example, as reactive diluent or as monomer in binder compositions for paints or adhesives.

The glycidyl esters compositions can be used as reactive diluent for epoxy based formulations such as exemplified in the technical brochure of Momentive (Product Bulletin: Cardura E10P The Unique Reactive Diluent MSC-521).

Other uses of the glycidyl ester are the combinations with polyester polyols, or acrylic polyols, or polyether polyols. The combination with polyester polyols such as the one used in the car industry coating leads to coating system with attractive coating appearance.

### METHODS USED

The isomer distribution of neo-acid can be determined using gas chromatography, using a flame ionization detector (FID). 0.5 ml sample is diluted in analytical grade dichloromethane and n-octanol may be used as internal standard. The conditions presented below result in the approximate retention times given in table 1. In that case n-octanol has a retention time of approximately 8.21 minute.

The GC method has the following settings:

| | |
|---|---|
| Column | CP Wax 58 CB (FFAP), 50 m × 0.25 mm, df = 0.2 μm |
| Oven program | 150° C. (1.5 min)-3.5° C./min-250° C. (5 min) = 35 min |
| Carrier gas | Helium |
| Flow | 2.0 mL/min constant |
| Split flow | 150 mL/min |
| Split ratio | 1:75 |
| Injector temp | 250° C. |
| Detector temp | 325° C. |
| Injection | 1 μL |
| volume | |

CP Wax 58 CB is a Gas chromatography column available from Agilent Technologies.

The isomers of neononanoic acid as illustrative example have the structure (R¹R²R³)—C—COOH where the three R groups are linear or branched alkyl groups having together a total of 7 carbon atoms.

The structures and the retention time, using the above method, of all theoretical possible neononanoic isomers are drawn in Scheme 1 and listed in Table 1.

The isomers content is calculated from the relative peak area of the chromatogram obtained assuming that the response factors of all isomers are the same.

TABLE 1
Structure of all possible neononanoic isomers

| | | | | Methyl | | Retention time |
|---|---|---|---|---|---|---|
| | R1 | R2 | R3 | groups | Blocking | [Minutes] |
| V901 | Methyl | Methyl | n-pentyl | 3 | No | 8.90 |
| V902 | Methyl | Methyl | 2-pentyl | 4 | Yes | −9.18 |
| V903 | Methyl | Methyl | 2-methyl butyl | 4 | No | 8.6 |
| V904 | Methyl | Methyl | 3-methyl butyl | 4 | No | 8.08 |
| V905 | Methyl | Methyl | 1,1-dimethyl propyl | 5 | Yes | 10.21 |
| V906 | Methyl | Methyl | 1,2-dimethy propyl | 5 | Yes | 9.57 |
| V907 | Methyl | Methyl | 2,2-dimethyl propyl | 5 | No | 8.26 |
| V908 | Methyl | Methyl | 3-pentyl | 4 | Yes | 9.45 |
| V909 | Methyl | Ethyl | n-butyl | 3 | No | 9.28 |
| V910 | Methyl | Ethyl | s-butyl | 4 | Yes | 9.74 |
| K1 | | | | | | |
| V910 | Methyl | Ethyl | s-butyl | 4 | Yes | 9.84 |
| K2 | | | | | | |
| V911 | Methyl | Ethyl | i-butyl | 4 | No | 8.71 |
| V912 | Methyl | Ethyl | t-butyl | 5 | Yes | 9.64 |
| V913 | Methyl | n-propyl | n-propyl | 3 | No | 8.96 |
| V914 | Methyl | n-propyl | i-propyl | 4 | Yes | 9.30 |
| V915 | Methyl | i-propyl | i-propyl | 5 | Yes | 9.74 |
| V916 | Ethyl | Ethyl | n-propyl | 3 | No | 9.44 |
| V917 | Ethyl | Ethyl | i-propyl | 4 | Yes | 10.00 |

The isomer distribution of glycidyl esters of neo-acid can be determined by gas chromatography, using a flame ionization detector (FID). 0.5 ml sample is diluted in analytical grade dichloromethane. The conditions presented below result in the approximate retention time given in Table 1.

The GC method has the following settings:

Column: CP Wax 58 CB (FFAP), 50 m×0.2 mm, df=0.52 μm

Oven: 175° C. (5 min)—1° C./min—190° C. (0 min)—10° C./min—275° C. (11.5 min)

Flow: 2.0 mL/min, constant flow

Carrier gas: Helium

Split ratio: 1:75

Injection volume: 1 μL

S/SL injector: 250° C.

CP Wax 58 CB is a Gas chromatography column available from Agilent Technologies.

The isomers of glycidyl esters of neononanoic acid as illustrative example have the structure (R¹R²R³)—C—COO—CH₂—CH(O)CH₂ where the three R groups are linear or branched alkyl groups having together a total of 7 carbon atoms.

The isomers content is calculated from the relative peak area of the chromatogram obtained assuming that the response factors of all isomers are the same.

GC-MS method can be used to identify the various isomers providing that the analysis is done by a skilled analytical expert.

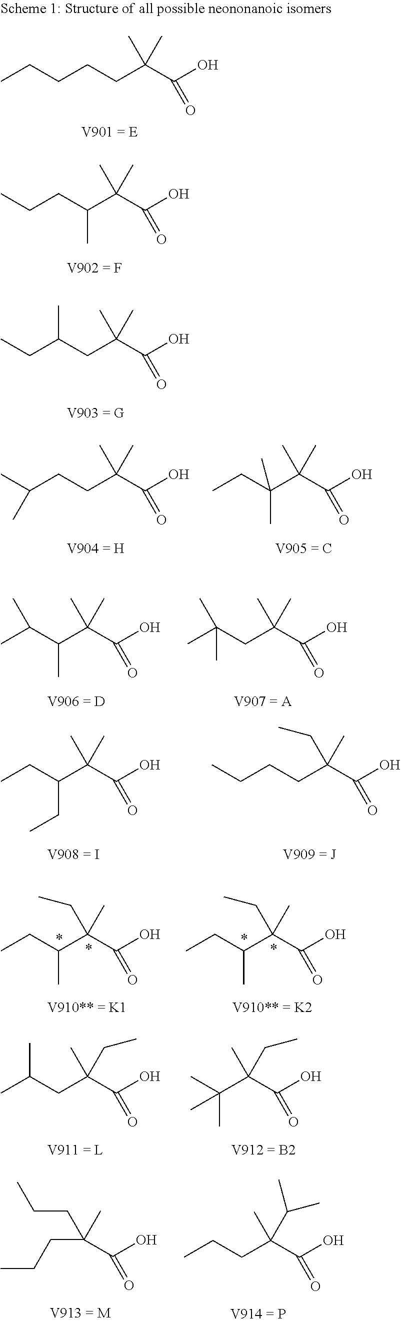

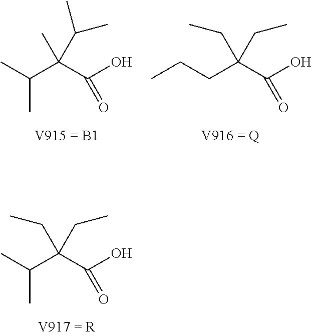

### Methods for the Characterization of the Resins

The molecular weights of the resins are measured with gel permeation chromatography (Perkin Elmer/Water) in THF solution using polystyrene standards. Viscosity of the resins are measured with Brookfield viscometer (LVDV-I) at indicated temperature. Solids content are calculated with a function (Ww−Wd)/Ww×100%. Here Ww is the weight of a wet sample, Wd is the weight of the sample after dried in an oven at a temperature 110° C. for 1 hour.

Tg (glass transition temperature) has been determined either with a DSC 7 from Perkin Elmer or with an apparatus from TA Instruments Thermal Analysis. Scan rates were respectively 20 and 10° C./min. Only data obtained in the same experimental conditions have been compared. If not, the temperature difference occurring from the different scanning rate has been proved not significant for the results compared.

### Blocking Isomers

Whereas the carbon atom in alpha position of the carboxylic acid is always a tertiary carbon atom, the carbon atom(s) in β position can either be primary, secondary or tertiary. Neononanoic acids (V9) with a secondary or a tertiary carbon atoms in the β position are defined as blocking (blocked) isomers (Schemes 2 and 3).

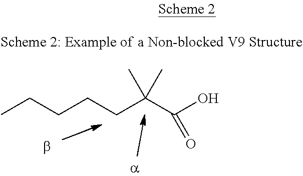

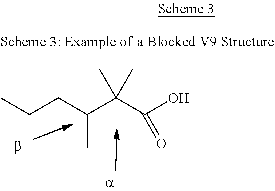

The use of the glycidyl esters compositions, discussed here above, can be as monomer in binder compositions for paints and adhesives. These binders can be based on a polyester polyol resin comprising the above composition glycidyl.

The polyester polyol resins of the invention are based on a composition of hydroxyl functional polyester resins (polyester polyols) comprising a mixture of α,α-branched alkane carboxylic glycidyl esters derived from butene oligomers characterized in that the sum of the concentration of the blocked and of the highly branched isomers is maximum 55%, preferably below 40%, and most preferably below 30% weight on total composition.

A preferred composition is that the glycidyl ester mixture is based on neononanoic (C9) acid mixture where the sum of the concentration of the blocked and of the highly branched isomers is maximum 55%, preferably below 40%, and most preferably below 30% weight on total composition.

Further the neononanoic (C9) glycidyl ester mixture is comprising 2,2-dimethyl heptanoic acid glycidyl ester or 2-methyl 2-ethyl hexanoic acid glycidyl ester or 2-methyl 2-ethyl 3-methyl pentanoic acid glycidyl ester.

Another embodiment is that the composition of the glycidyl ester mixture is comprising 2-methyl 2-ethyl 3-methyl pentanoic acid glycidyl esters (sum of stereoisomers) below 40%, preferably below 30% and most preferably below or equal 25% weight on total composition.

A further embodiment is that the composition of the glycidyl ester mixture is comprising 2-methyl 2-ethyl hexanoic acid glycidyl ester above 10%, preferably above 30% and most preferably above 45% weight on total composition.

A further embodiment is that the composition of the glycidyl ester mixture is comprising 2,2-dimethyl heptanoic acid glycidyl ester and 2-methyl 2-ethyl hexanoic acid glycidyl ester and 2-methyl 2-ethyl 3-methyl pentanoic acid glycidyl esters (sum of stereoisomers) is above 40%, preferably 55% and most preferably 65% weight on total composition.

A further embodiment is that the composition of the glycidyl ester mixture is comprising 2,2-dimethyl heptanoic acid glycidyl ester in 1 to 15 weight % and 2-methyl 2-ethyl hexanoic acid glycidyl ester in 40 to 70 weight % and 2-methyl 2-ethyl 3-methyl pentanoic acid glycidyl esters (sum of stereoisomers) in 8 to 32 weight % on total composition.

A further embodiment is that the composition of the glycidyl ester mixture is comprising 2,2-dimethyl heptanoic acid glycidyl ester in 2 to 10 weight % and 2-methyl to 2-ethyl hexanoic acid glycidyl ester in 47 to 61 weight % and 2-methyl 2-ethyl 3-methyl pentanoic acid glycidyl esters (sum of stereoisomers) in 10 to 25 weight % on total composition.

The process to prepare the compositions of the polyester polyol resin is obtained by the reaction of a polycarboxylic acid compound and a mixture of the α,α-branched alkane carboxylic glycidyl esters, in which the polycarboxylic acid compound is obtained by the polycondensation reaction of one or more multifunctional polyol with one or more anhydride or acid anhydride.

The glycidyl ester could be derived from the above C9 glycidyl ester composition or from a C10 glycidyl ester, which is commercially available as Cardura E10P (ex Momentive Specialty Chemicals Inc.).

The polycarboxylic acid compound can be selected from for example: phthalic, isophthalic, terephthalic, succinic, adipic, azelaic, sebacic, tetrahydrophthalic, hexahydrophthalic, HET, maleic, fumaric, itaconic, and trimellitic acids or any polycarboxylic acid derived from below indicated anhydrides or any mixture of these compounds.

The multifunctional polyol can be selected from for example: trimethylolpropane, ditrimethylolpropane, pentaerythritol, dipentaerythritol, tripentaerythritol, neopentyl glycol, glycerine, ethyleneglycol, cyclohexane dimethylol 1,4, mannitol, xylitol, isosorbide, erythritol, sorbitol, ethylene glycol, 1,2-propylene glycol, 1,2-butylene glycol, 2,3-butylene glycol, 1,2-hexanediol, 1,2-dihydroxycyclohexane, 3-ethoxypropane-1,2-diol and 3-phenoxypropane-1,2-diol; neopentyl glycol, 2-methyl-1,3-propanediol, 2-methyl-2,4-pentanediol, 3-methyl-1,3-butane diol, 2-ethyl-1,3-hexanediol, 2,2-diethyl-1,3-propanediol, 2,2,4-trimethyl-1,3-pentanediol, 2-butyl-2-ethyl-1,3-propanediol, 2-phenoxypropane-1,3-diol, 2-methyl-2-phenylpropane-1,3-diol, 1,3-propylene glycol, 1,3-butylene glycol, 2-ethyl-1,3-octanediol, 1,3-dihydroxycyclohexane, 1,4-butanediol, 1,4-dihydroxycyclohexane, 1,5-pentanediol, 1,6-hexanediol, 2,5-hexanediol, 3-methyl-1,5-pentanediol, 1,4-dimethylolcyclohexane, tricyclodecanedimethanol, 2,2-dimethyl-3-hydroxypropyl-2,2-dimethyl-3-hydroxypropyonate (an esterification product of hydroxy-pivalic acid with neopentyl glycol), 2,2,4-Trimethyl-1,3-pentanediol (TMPD), mixture of 1,3- and 1,4-cyclohexanedimethanol (=Unoxol diol ex Dow Chemicals), bisphenol A, bisphenol F, bis(4-hydroxyhexyl)-2,2-propane, bis(4-hydroxyhexyl)methane, 3,9-bis(1,1-dimethyl-2-hydroxyethyl)-2,4,8,10-tetroxaspiro[5,5]-undecane, di-ethylene glycol, triethylene glycol, glycerine, diglycerine, triglycerine, trimethylol-ethane and tris(2-hydroxyethyl)isocyanurate. Either pure multifunctional polyol can be used or mixtures of at least two of them.

The anhydride or acid anhydride can be selected from for example: succinic anhydride, maleic anhydride, phthalic anhydride, hexahydrophthalic anhydride, methylhexahydrophthalic anhydride, trimellitic anhydride, hydrogenated trimellitic anhydride, 1,2-cyclopentanedicarboxylic anhydride, tetrahydrophthalique anhydride, methyl tetrahydrophthalic anhydride,5-norbornene-2,3-dimethyl hydrogenated 5-norbornene-2,3-dicarboxilic anhydride, methyl-5-norbomene-2,3-dicarboxylic anhydride, hydrogenated methyl-5-norbornene-2,3-dicarboxylic anhydride, the Diels-Alder adduct of maleic anhydride with sorbic acid, the hydrogenated Diels-Alder adduct of maleic anhydride and sorbic acid. Either pure anhydride or acid anhydride can be used or mixtures of at least two of them. Commercially available product as Epikure 866, Epikure 854, Epikure 868 or Epikure 878 (all ex Momentive Specialty Chemicals Inc.) can be used as such or in mixture with the above given anhydrides or acids anhydrides.

The polyester polyol resins of the invention prepared according to the above processes will have a calculated hydroxyl value between 40 and 320 mgKOH/g on solid and the number average molecular weight (Mn) is between 500 and 7000 Dalton according polystyrene standard.

The polyester polyol resins of the invention prepared according to the above processes will have the acid value of the polyester polyol resin lower than 20 mg KOH/g on solids resins and preferably lower than 10 mg KOH/g on solids resins, most prefer lower than 6.

A further process to prepare the composition as described above wherein the polyester polyol is made from α,α-branched alkane carboxylic glycidyl esters.

A further process to prepare the composition the polyester polyol resin is made in the presence of an excess of α,α-branched alkane carboxylic glycidyl esters.

The invention is also related to a binder composition useful for coating composition comprising at least any hydroxyl functional polyester resins as prepared above.

The said binder compositions are suitable for coating metal or plastic substrates.

The said binder compositions are suitable for coating metal or plastic substrates. The polyester resin prior cured will be characterized by this glass transition temperature (Tg), which is for instance between 15 and 20° C. These resins when formulated in a curable composition will lead to high leveling of the cured film.

Binders based on the above compositions are especially suitable for a fast drying coating to be applied on an automotive substrate.

### EXAMPLES

### Chemicals Used

Cardura™ E10: available from Momentive Specialty Chemicals
Neononanoic glycidyl ester from Momentive Specialty Chemicals
GE9S: neononanoic glycidyl ester of composition A (see Table 2)
GE9H: neononanoic glycidyl ester of composition B (see Table 2)
Neononanoic glycidyl ester of composition C (see Table 2)
Neononanoic glycidyl ester of composition D (see Table 2)
Neononanoic glycidyl ester of composition E (see Table 2)

TABLE 2
Composition of the neononanoic glycidyl ester
(according to the described gas chromatography
method for glycidyl esters of neo-acid)

| Glycidyl ester | | | | | |
|---|---|---|---|---|---|
| of acid V9XX | | | | | |
| (described in | | | | | |
| Table 1) | A (%) | B (%) | C (%) | D (%) | E (%) |
| V901 | 6.5 | 0.1 | 3.7 | 0.1 | 8.9 |
| V902 | 0.6 | 2.55 | 0.6 | 2.4 | 0.7 |
| V903 | 1.1 | 0.7 | 0.3 | 1.0 | 2.0 |
| V904 | 0.8 | 1 | 0.1 | 2.2 | 1.8 |
| V905 | 0.2 | 13.1 | 0.5 | 4.1 | 0.1 |
| V906 | 0.4 | 11.6 | 0.4 | 9.6 | 0.4 |
| V907 | 0.2 | 15.4 | 0.1 | 36.4 | 0.6 |
| V908 | 0.1 | 0 | 0.1 | 0.0 | 0.1 |
| V909 | 54.8 | 2.55 | 52.8 | 2.4 | 52.8 |
| V910 K1 | 7.8 | 0 | 10.0 | 0.0 | 6.5 |
| V910 K2 | 7.7 | 0.6 | 12.8 | 0.4 | 4.8 |
| V911 | 2.4 | 1.2 | 0.7 | 2.0 | 4.2 |
| V912 | 0.0 | 28.3 | 0.0 | 22.4 | 0.0 |
| V913 | 6.8 | 0.1 | 6.4 | 0.1 | 6.5 |
| V914 | 4.5 | 0 | 3.8 | 0.0 | 5.7 |
| V915 | 0.6 | 22.3 | 0.6 | 16.8 | 0.4 |
| V916 | 4.4 | 0.1 | 5.2 | 0.1 | 3.8 |
| V917 | 1.1 | 0.4 | 2.1 | 0.1 | 0.5 |

GE5: glycidyl ester of pivalic acid obtained by reaction of the acid with epichlorhydrin.
Ethylene glycol from Aldrich
Monopentaerythritol: available from Sigma-Aldrich
3,3,5 Trimethyl cyclohexanol: available from Sigma-Aldrich
Maleic anhydride: available from Sigma-Aldrich
Methylhexahydrophtalic anhydride: available from Sigma-Aldrich
Hexahydrophtalic anhydride: available from Sigma Aldrich
Boron trifluoride diethyl etherate (BF3.OEt2) from Aldrich
Acrylic acid: available from Sigma Aldrich
Methacrylic acid: available from Sigma-Aldrich
Hydroxyethyl methacrylate: available from Sigma-Aldrich
Styrene: available from Sigma-Aldrich
2-Ethylhexyl acrylate: available from Sigma-Aldrich
Methyl methacrylate: available from Sigma-Aldrich
Butyl acrylate: available from Sigma-Aldrich
Di-t-Amyl Peroxide is Luperox DTA from Arkema
tert-Butyl peroxy-3,5,5-trimethylhexanoate: available from Akzo Nobel
Xylene
n-Butyl Acetate from Aldrich
Dichloromethane from Biosolve
Thinner: A: is a mixture of Xylene 50 wt %, Toluene 30 wt %, ShellsolA 10 wt %, 2-Ethoxyethylacetate 10 wt %. Thinner B: is butyl acetate
Curing agents, HDI: 1,6-hexamethylene diisocyanate trimer, Desmodur N3390 BA from Bayer Material Science or Tolonate HDT LV2 from Perstorp
Leveling agent: ‘BYK 10 wt %’ which is BYK-331 diluted at 10% in butyl acetate
Catalyst: ‘DBTDL 1 wt %’ which is Dibutyl Tin Dilaurate diluted at 1 wt % in butyl acetate
Catalyst: ‘DBTDL 10 wt %’ which is Dibutyl Tin Dilaurate diluted at 10 wt % in butyl acetate

### Example 01

The following constituents were charged to a reaction vessel: 0.7153 grams of a neononanoic glycidyl ester of composition C, 0.5958 grams of hexahydro-4-methylphthalic anhydride, 0.0014 grams of ethylene glycol. The reaction took place for 3 to 4 days at 140° C. The sample has been dried by evaporation. The polyester had a molecular weight (Mn) of 4700 Daltons and a Tg of +18.8° C.

### Example 02 Comparative

The following constituents were charged to a reaction vessel: 0.5823 grams of a neononanoic glycidyl ester of composition D, 0.4775 grams of hexahydro-4-methylphthalic anhydride, 0.0011 grams of ethylene glycol, 0.2841 grams of n-Butyl Acetate. The reaction took place for 3 to 4 days at 120-140° C. and the solvent was then thoroughly removed by evaporation. The polyester had a molecular weight (Mn) of 5000 Daltons and a Tg of +43.7° C.

### Example 03

The following constituents were charged to a reaction vessel: 0.7235 grams of a neononanoic glycidyl ester of composition E, 0.5981 grams of hexahydro-4-methylphthalic anhydride, 0.0014 grams of ethylene glycol. The reaction took place for 3 to 4 days at 140° C. The sample has been dried by evaporation. The polyester had a molecular weight (Mn) of 5700 Daltons and a Tg of +17.6° C.

Observations:

Tg of polyesters is impacted by the composition of the neononanoic glycidyl ester (see examples 01, 02, 03).

The resins of the examples can be formulated in coating compositions such as 2K (polyurethane) with a low VOC (volatile organic compound) level and still providing and excellent appearance.

### Example 04

### Monopentaerythritol/Methylhexahydrophtalic Anhydride/GE9S (1/3/3 molar ratio)=CE-GE9S

80.4 g amount of butylacetate, 68.3 g of monopentaerythritol, 258.2 g of methylhexahydrophthalic anhydride are loaded in a glass reactor and heated to reflux until complete dissolution. Afterwards, the temperature is decreased down to 120° C. and 333.0 g of GE9S are added over about one hour. The cooking is pursued at 120° C. for the time needed to decrease epoxy group content and acid value down to an acid value below 15 mg KOH/g. Then, further 82.4 g of butylacetate are added. Test results are indicated in Table 3.

### Example 05 Comparative

### Monopentaerythritol/Methylhexahydrophtalic Anhydride/GE9H (1/3/3 Molar Ratio)=CE-GE9Ha

80.4 g amount of butylacetate, 68.3 g of monopentaerythritol, 258.2 g of methylhexahydrophthalic anhydride are loaded in a glass reactor and heated to reflux until complete dissolution. Afterwards, the temperature is decreased down to 120° C. and 337.1 g of GE9H are added over about one hour. The cooking is pursued at 120° C. for the time needed to decrease epoxy group content and acid value down to an acid value below 15 mg KOH/g. Then, further 83.4 g of butylacetate are added. Test results are indicated in Table 3.

TABLE 3
Polyesters characterization

| | SC | Mw | Mn | Mw/Mn | Viscosity |
|---|---|---|---|---|---|
| Polyester resin | (%) | (Da) | (Da) | (PDI) | (cP) |
| CE-GE9S | 78.6 | 974 | 919 | 1.06 | 2450 |
| CE-GE9Ha | 80.0 | 921 | 877 | 1.05 | 6220 |

SC: solids content

### Formulation of the Clear Coats

The clearcoat has been formulated as follows: CE-GEx polyester with Tolonate HDT LV2 as hardener (0.03 wt % DBTDL) (see Table 4).

TABLE 4
Clear coats, formulations

| | | | | DBTDL | |
|---|---|---|---|---|---|
| | Binder 2 | HDI | BYK 10 wt % | 1 wt % | Thinner B |
| CE-GEx | (g) | (g) | (g) | (g) | (g) |
| GE9S | 80.0 | 36.56 | 0.72 | 3.15 | 89.75 |
| GE9Ha | 80.4 | 37.27 | 0.73 | 3.20 | 87.83 |

### Characterization of the Clear Coats

The clearcoat formulations are barcoat applied on degreased Q-panel. The panels are dried at room temperature, optionally with a preliminary stoving at 60° C. for 30 min. Results are indicated in Table 5.

TABLE 5
Clear coats, performances

| | | | DFT | | | |
|---|---|---|---|---|---|---|
| | | | (min) | Koenig Hardness | | |
| | SC | Drying | Cotton | (s) | | |
| CE-GEx | (%) | conditions | Balls | 6 h | 24 h | 7 d |
| GE9S | 48.4 | RT | 223 | 3 | 17 | 159 |
| GE9Ha | 49.2 | RT | 91 | 3 | 36 | 212 |
| GE9S | 48.4 | Stoving 30 | Dust | 4 | 44 | 174 |
| | | min/60° C. | free out | | | |
| | | | of oven | | | |
| GE9Ha | 49.2 | Stoving 30 | Dust | 10 | 55 | 211 |
| | | min/60° C. | free out | | | |
| | | | of oven | | | |

### Example 06

### Trimethylolpropane/Hexahydrophtalic Anhydride/GE9S (1/2/2 Molar Ratio)

30.2 g amount of butylacetate, 31.6 g of trimethylolpropane, 70.3 g of hexahydrophthalic anhydride and 1.3 g of a DBTDL 10 wt % are loaded in a glass reactor and heated to reflux until complete dissolution. Afterwards, the temperature is decreased down to 120° C. and 104.8 g of GE9S are added over about one hour. The cooking is pursued at 120° C. for the time needed to decrease epoxy group content and acid value down to an acid value below 15 mg KOH/g. Then, further 20.0 g of butylacetate are added.

### Example 07

### Monopentaerythritol/Methylhexahydrophtalic Anhydride/Cardura™ E10 (1/3/3)=CE-CE10a

338.7 g amount of butylacetate, 136.6 g of Monopentaerythritol, 516.8 g of Methylhexahydrophtalic anhydride and 10 g of DBTDL 10 wt % are loaded in a glass reactor and heated to reflux until complete dissolution. Afterwards, the temperature is decreased and 718 g of Cardura™ E10 are added over about one hour. The cooking is pursued for the time needed to decrease the acid value around 24 mgKOH/g. Test results are indicated in Table 6.

### Example 08

### Monopentaerythritol/Methylhexahydrophtalic Anhydride/Cardura™ E10 (1/3/3)=CE-CE10b

338.7 g amount of butylacetate, 136.6 g of Monopentaerythritol, 516.8 g of Methylhexahydrophtalic anhydride and 10 g of DBTDL 10 wt % are loaded in a glass reactor and heated to reflux until complete dissolution. Afterwards, the temperature is decreased and 718 g of Cardura™ E10 are added over about one hour. The cooking is pursued for the time needed to decrease the acid value around 18 mgKOH/g. Test results are indicated in Table 6.

### Example 09

### Monopentaerythritol/Methylhexahydrophtalic Anhydride/Cardura™ E10 (1/3/3)=CE-CE10c

338.7 g amount of butylacetate, 136.6 g of Monopentaerythritol, 516.8 g of Methylhexahydrophtalic anhydride and 10 g of DBTDL 10 wt % are loaded in a glass reactor and heated to reflux until complete dissolution. Afterwards, the temperature is decreased and 718 g of Cardura™ E10 are added over about one hour. The cooking is pursued for the time needed to decrease the acid value around 8 mgKOH/g. Test results are indicated in Table 6.

### Example 10

### Monopentaerythritol/Methylhexahydrophtalic Anhydride/Cardura™ E10 (1/3/3)=CE-CE10d

338.7 g amount of butylacetate, 136.6 g of Monopentaerythritol, 516.8 g of Methylhexahydrophtalic anhydride and 10 g of DBTDL 10 wt % are loaded in a glass reactor and heated to reflux until complete dissolution. Afterwards, the temperature is decreased and 718 g of Cardura™ E10 are added over about one hour. The cooking is pursued for the time needed to decrease the acid value around 2 mgKOH/g. Test results are indicated in Table 6.

TABLE 6
Polyesters characterization

| | SC | Mw | Mn | Mw/Mn | Acid value |
|---|---|---|---|---|---|
| Polyester resin | (%) | (Da) | (Da) | (PDI) | (mg KOH/g) |
| CE-CE10a | 77.0 | 1230 | 1184 | 1.04 | 24.3 |
| CE-CE10b | 79.3 | 1192 | 1147 | 1.04 | 18.2 |
| CE-CE10c | 79.5 | 1197 | 1151 | 1.04 | 8.3 |
| CE-CE10d | 79.3 | 1213 | 1165 | 1.04 | 1.6 |

SC: solids content

### Formulation and Characterization of the Clear Coats

Clearcoat formulations have been prepared as indicated in Table 7.

TABLE 7
Clearcoats, formulations

| | | | | BYK 10 | DBTDL | Thinner |
|---|---|---|---|---|---|---|
| CE- | Binder 4 | Binder 2 | HDI | wt % | 1 wt % | A |
| CE10x | (g) | (g) | (g) | (g) | (g) | (g) |
| CE- | 70.3 | 19.4 | 34.5 | 0.65 | 1.45 | 42.86 |
| CE10a | | | | | | |
| CE- | 70.08 | 19.2 | 34.8 | 0.66 | 1.45 | 42.08 |
| CE10b | | | | | | |
| CE- | 71.2 | 18.9 | 34.7 | 0.66 | 1.45 | 42.03 |
| CE10c | | | | | | |
| CE- | 70.09 | 18.90 | 34.5 | 0.65 | 1.44 | 41.98 |
| CE10d | | | | | | |

Binder 4: Acryl-CE(10)b from example 14
Binder 2: CE-CE10x polyesters

The clearcoat formulations are sprayed on base-coated degreased Q-panel. The panels are dried at room temperature, optionally with a preliminary stoving at 60° C. for 30 min. Test results are indicated in Table 8

TABLE 8
Clear coats, performances

| | | | | Koenig Hardness | | |
|---|---|---|---|---|---|---|
| | SC | Potlife | Drying | (s) | | DFT |
| CE-GEx | (%) | (min) | conditions | 6 h | 24 h | (min) |
| CE- | 54.8 | 4.6 | RT | 0 | 12 | 16 |
| CE10a | | | | | | |
| CE- | 54.8 | 4.3 | RT | 3 | 13 | 12.5 |
| CE10b | | | | | | |
| CE- | 52.3 | 1.6 | RT | 4 | 14.5 | 10.5 |
| CE 10c | | | | | | |
| CE- | 48.1 | 0.9 | RT | 7 | 17 | 9.5 |
| CE10d | | | | | | |

Observations:

Koenig Hardness of clearcoats is impacted by the acid value of the CE-CE10x polyesters.

### Example 11

### Maleate Diester Based Resin Prepared According to the Teaching of WO2005040241

Equipment: Glass reactor equipped with an anchor stirrer, reflux condenser and nitrogen flush.

Manufacturing procedure of the maleate diester:

Maleic anhydride was reacted with the selected alcohol (3,3,5 trimethyl cyclohexanol) in an equimolar ratio at 110° C. to form a maleate monoester in presence of around 5 wt % butyl acetate. The reaction was continued until conversion of the anhydride had reached at least 90% (Conversion of the anhydride is monitored by acid-base titration.). Methanol was added to open the remaining anhydride in a 1.2/1 molar ratio of methanol/anhydride and the reaction was continued for 30 minutes.

GE9S was fed to the reactor in 30 minutes in an equimolar ratio to the remaining acid in the system whilst keeping the temperature at 110° C. The system was then allowed to react further for 1 hour at 110° C.

Manufacturing Procedure of the Maleate-Acrylic Resin (See Table 9):

The reactor was flushed with nitrogen and the initial reactor charge was heated to the polymerization temperature of 150° C. The first charge of Di ter-amylperoxide was then added in one shot. Immediately after this addition, the monomer-initiator mixture was dosed continuously to the reactor in 330 minutes at the same temperature. The monomer addition feed rate was halved during the last hour of monomer addition. After completion of the monomer addition, the third charge of Di ter-amylperoxide was then fed together with a small amount of the butyl acetate to the reactor in 15 minutes. The reactor was kept at this temperature for 60 more minutes. Finally, the polymer was cooled down.

TABLE 9
Composition of TMCH maleate based resin

| | | Parts by |
|---|---|---|
| | | weight |
| Initial Reactor | BuAc | 8 |
| Charge [g] | Maleate diester | 40.7 |
| Initiator start [g] | Di tert amyl peroxide | 0.4 |
| Monomer feed [g] | BuAc | 3 |
| | Hydroxyethyl methacrylate | 21.5 |
| | Styrene | 20 |
| | Methyl methacrylate | 17.8 |
| | Methacrylic Acid | 2.2 |
| | Di tert amyl peroxide | 3.6 |
| Post cooking [g] | DTAP (with 10 g BuAc) | 1 |
| Total intake [g] | | 118.2 |

### Example 12

### Polyester-Ether Resin

The following constituents were charged to a reaction vessel equipped with a stirrer, a thermometer and a condenser: 456 g of GE9S, 134 g of dimethylolpropionic acid and 0.35 g of stannous octoate.

The mixture was heated to a temperature of about 110° C. for about 1 hour and then steadily increased to 150° C. in 3 hours and then cooled down.

This polyester-ether was then formulated in high solids and very high solids 2K polyurethane topcoats either as sole binder or as reactive diluent for an acrylic polyol.

### Example 13

### Example of Polyester Powder Prepared According to the Teaching of U.S. Pat. No. 4,145,370

250.8 g of propylene glycol, 871.5 g of terephthalic acid, 287.0 g of neopentyl glycol and 65.7 g of adipic acid were charged to a reactor together with 0.3 g of dibutyl tin oxide as catalyst. This batch was then heated to 194° C. whereupon distillation of water from the reactor commenced. The reactor temperature rose to 205° C. and the amount of water distilled over was 60.0 ml. 69.0 g of GE9S was then added and the temperature of the reactor was increased to 245° C. until the product had an acid value of 6.5 mg KOH/g. At this point the total water distilled was over 200 ml. The temperature of the batch was then reduced to 190° C. and 220.0 g of trimellitic anhydride was added. The batch was held at this temperature until the product had an acid value of 99 and was then cooled and discharged.

### Example 14

### Cardura™ E10 Based Acrylic Polyol Resin: Acryl-CE(10)b

300 g amount of CE10 (Cardura™ E10-glycidyl ester of Versatic acid) and 32.4 g of Xylene are loaded in a glass reactor and heated up to 157° C. Then, a mixture of monomers (86.4 g acrylic acid, 216 g hydroxyethyl methacrylate, 360 g styrene, 237.6 g methyl methacrylate), solvent (99.6 g of Xylene) and initiator (48 g Di-tert-amyl peroxide) is fed into the reactor at a constant rate in 6 hours. Then post cooking started: a mixture of 12 g Di-tert-amyl peroxide is fed into the reactor at a constant rate in 0.5 hour, then temperature maintained at about 157.5° C. for a further 0.5 hour. Finally, 504 g of n-butyl acetate is added under stirring to achieve a polyol resin with the target solids content. Test results are indicated in Table 10.

TABLE 10
Acryl-CE(10)b characterization

| | SC (%) - | Mw | Mn | Mw/Mn |
|---|---|---|---|---|
| Acryl- | measured | (Da) | (Da) | (PDI) |
| CE(10)b | 62.4 | 3142 | 2145 | 1.46 |

1. A polyester polyol resin composition comprising a mixture of α,α-branched alkane carboxylic glycidyl esters wherein a sum of a concentration of blocked and of highly branched isomers is a maximum amount of 55 wt % based on the total weight of the mixture.

2. The composition of claim 1 wherein the mixture of α,α-branched alkane carboxylic glycidyl esters is based on a neononanoic (C9) acid mixture wherein the sum of the concentration of the blocked isomers and of the highly branched isomers is a maximum amount of 55 wt % based on the total weight of the mixture.

3. The composition of claim 2 wherein the mixture of α,α-branched alkane carboxylic glycidyl esters comprises 2,2-dimethyl heptanoic acid glycidyl ester, or 2-methyl 2-ethyl hexanoic acid glycidyl ester or 2-methyl 2-ethyl 3-methyl pentanoic acid glycidyl esters.

4. The composition of claim 2 wherein the mixture of α,α-branched alkane carboxylic glycidyl esters comprises 2-methyl 2-ethyl 3-methyl pentanoic acid glycidyl ester stereoisomers in an amount below 40 wt % based on the total weight of the mixture.

5. The composition of claim 2 wherein the mixture of α,α-branched alkane carboxylic glycidyl esters comprises 2-methyl 2-ethyl hexanoic acid glycidyl ester in an amount above 10 wt % based on the total weight of the mixture.

6. The composition of claim 2 wherein the mixture of α,α-branched alkane carboxylic glycidyl esters comprises 2,2-dimethyl heptanoic acid glycidyl ester, 2-methyl 2-ethyl hexanoic acid glycidyl ester and 2-methyl 2-ethyl 3-methyl pentanoic acid glycidyl ester stereoisomers in an amount above 40 wt % based on the total weight of the mixture.

7. The composition of claim 2 wherein the mixture of α,α-branched alkane carboxylic glycidyl esters comprises 2,2-dimethyl heptanoic acid glycidyl ester in an amount of 1 to 15 wt %, 2 methyl 2-ethyl hexanoic acid glycidyl ester in an amount of 40 to 70 wt % and 2-methyl 2-ethyl 3-methyl pentanoic acid glycidyl ester stereoisomers in an amount of 8 to 32 wt % based on the total weight of the mixture.

8. The composition of claim 2 wherein the mixture of α,α-branched alkane carboxylic glycidyl esters comprises 2,2-dimethyl heptanoic acid glycidyl ester in an amount of 2 to 10 wt %, 2-methyl 2-ethyl hexanoic acid glycidyl ester in an amount of 47 to 61 wt % and 2-methyl 2-ethyl 3-methyl pentanoic acid glycidyl ester stereoisomers in an amount of 10 to 25 wt % based on the total weight of the mixture.

9. The A process to prepare the polyester polyol resin composition of claim 1 comprising reacting a polycarboxylic acid compound and the mixture of the α,α-branched alkane carboxylic glycidyl esters, wherein the polycarboxylic acid compound is obtained by a polycondensation reaction of one or more multifunctional polyol with one or more anhydride or acid anhydride.

10. The process of claim 9 wherein the polyester polyol resin composition has an acid value lower than 20 mg KOH/g on solids.

11. The process of claim 9 wherein the polyester polyol resin composition has a number average molecular weight (Mn) between 500 and 7000 Dalton according polystyrene standard or has an hydroxyl value between 40 and 320 mg KOH/g on solids.

12. A binder composition useful for a coating composition comprising the polyester polyol resin composition of claim 1.

13. A metal or plastic substrate coated with a coating composition comprising the binder composition of claim 12.

14. The binder composition of claim 12 wherein the coating composition comprises 10 to 40 weight % of aliphatic isocyanate, 5-25 weight % of the polyester polyol resin composition of claim 1, and 65-40 weight % acrylic polyol, all weight % based on solid material after evaporation of the solvents.

15. The polyester polyol resin composition of claim 1 prepared in presence of an acrylic polyol.

16. A reaction product of a secondary alcohol and maleic anhydride which has been subsequently reacted with the polyester polyol resin composition of claim 1.

17. A polyester-ether resin comprising a reaction product of the polyester polyol resin composition of claim 1 and dimethylol propionic acid.

18. A polyester based powder coatings composition comprising 1-20 wt % of the polyester polyol resin composition of claim 1.

19. The composition of claim 1 wherein the sum of the concentration of the blocked isomers and of the highly branched isomers is below 40 wt % based on the total weight of the mixture.

20. The composition of claim 1 wherein the sum of the concentration of the blocked isomers and of the highly branched isomers is below 30 wt % based on the weight of the mixture.

21. The composition of claim 2 wherein the sum of the concentration of the blocked isomers and of the highly branched isomers is below 40 wt % based on the total weight of the mixture.

22. The composition of claim 2 wherein the sum of the concentration of the blocked isomers and of the highly branched isomers is below 30 wt % based on the total weight of the mixture.

23. The composition of claim 4 wherein the mixture of α,α-branched alkane carboxylic glycidyl esters comprises 2-methyl 2-ethyl 3-methyl pentanoic acid glycidyl ester stereoisomers in an amount below 30 wt % based on the total weight of the mixture.

24. The composition of claim 4 wherein the mixture of α,α-branched alkane carboxylic glycidyl esters comprises 2-methyl 2-ethyl 3-methyl pentanoic acid glycidyl ester stereoisomers in an amount below or equal to 25 wt % based on the total weight of the mixture.

25. The composition of claim 5 wherein the mixture of α,α-branched alkane carboxylic glycidyl esters comprises 2-methyl 2-ethyl hexanoic acid glycidyl ester in an amount above 30 wt % based on the total weight of the mixture.

26. The composition of claim 5 wherein the mixture of α,α-branched alkane carboxylic glycidyl esters comprises 2-methyl 2-ethyl hexanoic acid glycidyl ester in an amount above 45 wt % based on the total weight of the mixture.

27. The composition of claim 6 wherein the mixture of α,α-branched alkane carboxylic glycidyl esters comprises 2,2-dimethyl heptanoic acid glycidyl ester, 2-methyl 2-ethyl hexanoic acid glycidyl ester and 2-methyl 2-ethyl 3-methyl pentanoic acid glycidyl ester stereoisomers in an amount above 55 wt % based on the total weight of the mixture.

28. The composition of claim 6 wherein the mixture of α,α-branched alkane carboxylic glycidyl esters comprises 2,2-dimethyl heptanoic acid glycidyl ester, 2-methyl 2-ethyl hexanoic acid glycidyl ester and 2-methyl 2-ethyl 3-methyl pentanoic acid glycidyl ester stereoisomers in an amount above 65 wt % based on the total weight of the mixture.

29. The composition of claim 1 wherein the mixture of α,α-branched alkane carboxylic glycidyl esters is derived from butene oligomers.
